(19) United States
(12) Patent Application Publication
(10) Pub. No.: US 2025/0266468 A1
(43) Pub. Date: Aug. 21, 2025

(54) ELECTROCHEMICAL CELL

(71) Applicant: NGK INSULATORS, LTD., Nagoya-shi (JP)

(72) Inventors: Shiko IWASAKI, Nagoya-shi (JP); Kazuhiro MIZUKI, Kuwana-shi (JP); Naoya AKIYAMA, Nagoya-shi (JP); Shinji FUJISAKI, Kuwana-shi (JP); Makoto OHMORI, Nagoya-shi (JP)

(21) Appl. No.: 19/199,483

(22) Filed: May 6, 2025

Related U.S. Application Data
(63) Continuation of application No. PCT/JP2023/041834, filed on Nov. 21, 2023.

(30) Foreign Application Priority Data
Dec. 6, 2022 (JP) 2022-195066

(51) Int. Cl. H01M 8/00; H01M 8/0232; H01M 8/0236; H01M 8/0241

(52) U.S. Cl. CPC H01M 8/006; H01M 8/0232; H01M 8/0236; H01M 8/0241

(57) ABSTRACT

An electrochemical cell includes a support body, a first electrode layer, an electrolyte layer, and a second electrode layer. The first electrode layer is disposed on the support body. The electrolyte layer is disposed on the first electrode layer. The second electrode layer is disposed on the side opposite to the first electrode layer with respect to the electrolyte layer. The support has a current collecting layer, a beam portion embedded in the current collecting layer, and a through hole that penetrates along a stacking direction from a first main surface opposite to the first electrode layer to a second main surface facing the first electrode layer.

### CROSS-REFERENCE TO RELATED APPLICATION

This is a continuation of PCT/JP2023/041834, filed Nov. 21, 2023, which claims priority from Japanese Application No. 2022-195066, filed Dec. 6, 2022 the entire content of which is hereby incorporated by reference.

### TECHNICAL FIELD

The present invention relates to an electrochemical cell.

### BACKGROUND ART

There have been conventionally known electrode-supported electrochemical cells (electrolytic cells, fuel cells, and the like) that have an electrolyte layer interposed between two electrode layers, one of which functions as a support body.

For example, JP 2014-049322A discloses an anode-supported fuel cell in which, out of the anode, the cathode, and the electrolyte, the anode is the thickest, and the anode functions as a support body.

### SUMMARY

However, even if the thickness of the electrode layer functioning as a support body is increased, it is difficult to obtain sufficient rigidity because the electrode layer is porous. Therefore, the electrochemical cell may become warped as the temperature rises and falls during reduction treatment or operation.

An object of the present invention is to provide an electrochemical cell that is capable of suppressing warping.

An electrochemical cell according to a first aspect of the present invention includes a support body, a first electrode layer, an electrolyte layer, and a second electrode layer. The first electrode layer is disposed on the support body. The electrolyte layer is disposed on the first electrode layer. The second electrode layer is disposed on the side opposite to the first electrode layer with respect to the electrolyte layer. The support has a current collecting layer, a beam portion embedded in the current collecting layer, and a through hole that penetrates along a stacking direction from a first main surface opposite to the first electrode layer to a second main surface facing the first electrode layer.

An electrochemical cell according to a second aspect of the present invention relates to the electrochemical cell according to the first aspect, wherein a first surface of the beam portion on the side opposite to the first electrode layer is covered with the current collecting layer.

An electrochemical cell according to a third aspect of the present invention relates to the electrochemical cell according to the first or second aspect, wherein a second surface of the beam portion facing the first electrode layer is covered with the current collecting layer.

An electrochemical cell according to a fourth aspect of the present invention relates to the electrochemical cell according to any one of the first to third aspects, wherein the support body has a frame body that surrounds a side periphery of the current collecting layer and to which the beam portion is coupled.

An electrochemical cell according to a fifth aspect of the present invention relates to the electrochemical cell according to any one of the first to fourth aspects, wherein the support body has a beam structural body constituted by a plurality of the beam portions.

An electrochemical cell according to a sixth aspect of the present invention relates to the electrochemical cell according to the fifth aspect, wherein the beam structural body has lattice structure.

According to the present invention, it is possible to provide an electrochemical cell that is capable of suppressing warping.

### BRIEF DESCRIPTION OF DRAWINGS

FIG. 1 is a cross-sectional view of an electrolytic cell according to an embodiment.

FIG. 2 is a perspective view of a support body according to the embodiment.

FIG. 3 is a cross-sectional view of an electrolytic cell according to Modification 1.

FIG. 4 is a cross-sectional view of an electrolytic cell according to Modification 2.

FIG. 5 is a cross-sectional view of an electrolytic cell according to Modification 3.

### DESCRIPTION OF EMBODIMENTS

### (Configuration of Electrolytic Cell 10)

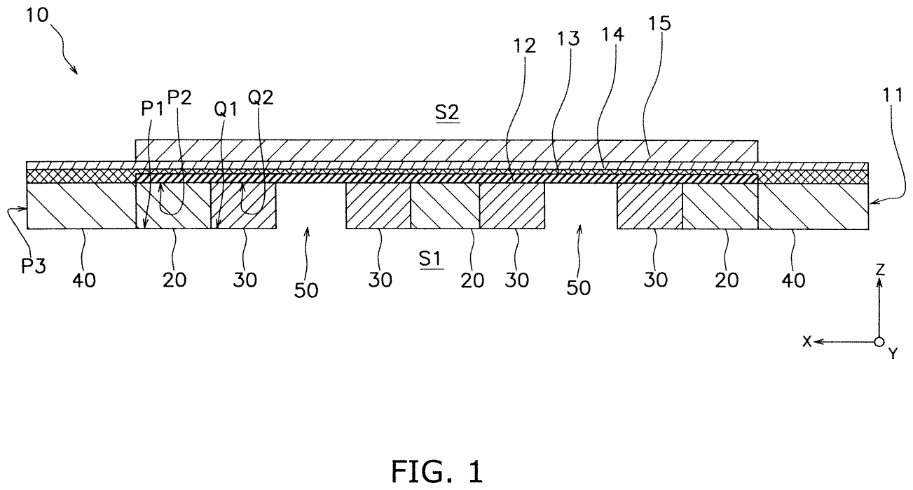

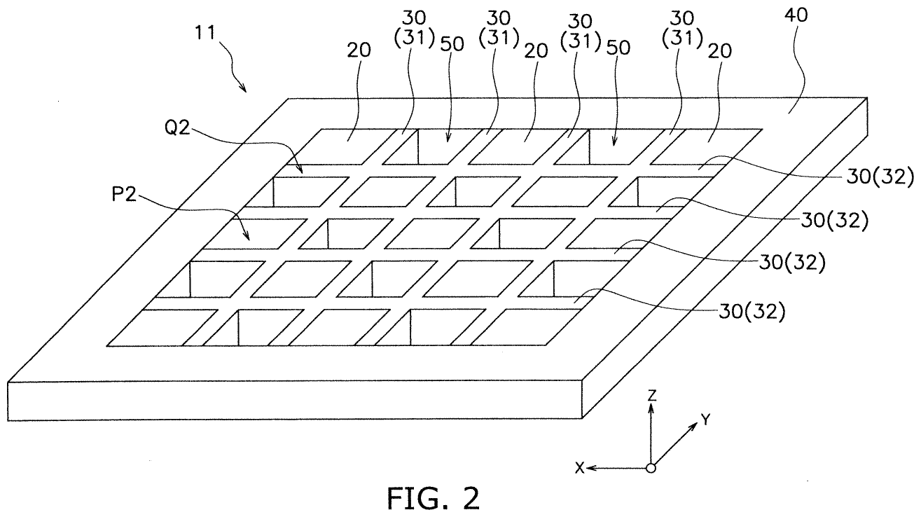

FIG. 1 is a cross-sectional view of an electrolytic cell 10 according to an embodiment. FIG. 2 is a perspective view of a support body 11 according to the embodiment. The electrolytic cell 10 is an example of an “electrochemical cell” according to the present invention.

As shown in FIG. 1, the electrolytic cell 10 includes a support body 11, a hydrogen electrode active layer 12, an electrolyte layer 13, a reaction prevention layer 14, and an oxygen electrode layer 15. The hydrogen electrode active layer 12 is an example of a “first electrode layer” according to the present invention. The oxygen electrode layer 15 is an example of a “second electrode layer” according to the present invention.

In the electrolytic cell 10, the support body 11, the hydrogen electrode active layer 12, the electrolyte layer 13, and the oxygen electrode layer 15 are essential components, whereas the reaction prevention layer 14 is an optional component.

The support body 11, the hydrogen electrode active layer 12, the electrolyte layer 13, the reaction prevention layer 14, and the oxygen electrode layer 15 are stacked in this order in a Z-axis direction. The Z-axis direction is perpendicular to an X-axis direction and a Y-axis direction. The Z-axis direction is an example of the “stacking direction” according to the present invention.

### [Support Body 11]

As shown in FIGS. 1 and 2, the support body 11 is formed in a plate shape. The support body 11 has a first main surface P1, a second main surface P2, and a side surface P3. The first main surface P1 is electrically connected to a separator not shown. The first main surface P1 faces a hydrogen electrode-side space S1 into which a raw material gas is supplied. The second main surface P2 is provided on the side opposite to the first main surface P1 in the Z-axis direction. The second main surface P2 is connected to the hydrogen electrode active layer 12. The side surface P3 is continuous with the first main surface P1 and the second main surface P2. The side surface P3 may be perpendicular to the first main surface P1 and the second main surface P2, or may be inclined with respect to the first main surface P1 and the second main surface P2.

The thickness of the support body 11 is not particularly limited, but may be 150 μm or more and 1000 μm or less, for example. In the Z-axis direction, the thickness of the support body 11 may be greater than the thicknesses of the hydrogen electrode active layer 12, the electrolyte layer 13, the reaction prevention layer 14, and the oxygen electrode layer 15.

As shown in FIGS. 1 and 2, the support body 11 has a hydrogen electrode current collecting layer 20, a beam structural body 30, a frame body 40, and through holes 50. The hydrogen electrode current collecting layer 20 is an example of a “current collecting layer” according to the present invention.

### [Hydrogen Electrode Current Collecting Layer 20]

The beam structural body 30 is embedded in the hydrogen electrode current collecting layer 20. In the present embodiment, the hydrogen electrode current collecting layer 20 is divided into small compartments by the beam structural body 30.

The hydrogen electrode current collecting layer 20 is supported by the beam structural body 30. In the present embodiment, the hydrogen electrode current collecting layer 20 is also supported by the frame body 40. The hydrogen electrode current collecting layer 20 functions as a support body for the electrolytic cell 10, together with the beam structural body 30 and the frame body 40. The electrolytic cell 10 according to the present embodiment is an electrode-supported electrochemical cell.

The hydrogen electrode current collecting layer 20 has a current collecting function. The hydrogen electrode current collecting layer 20 has electron conductivity. The hydrogen electrode current collecting layer 20 contains nickel (Ni). In the case of co-electrolysis, Ni functions as an electron conductor and also functions as a thermal catalyst that promotes thermal reaction between H₂ generated in the hydrogen electrode active layer 12 and CO₂ contained in the raw material gas to maintain a gas composition suitable for methanation and Fischer-Tropsch (FT) synthesis. The Ni contained in the hydrogen electrode current collecting layer 20 is basically present in the form of metallic Ni during the operation of the electrolytic cell 10, but a portion of it may be present in the form of nickel oxide (NiO).

The hydrogen electrode current collecting layer 20 contains a ceramic in addition to nickel (Ni). The ceramic may have ion conductivity. Examples of the ceramic include yttria (Y₂O₃), magnesia (MgO), iron oxide (Fe₂O₃), zirconia (ZrO₂, including partially stabilized zirconia), yttria stabilized zirconia (YSZ), calcia stabilized zirconia (CSZ), scandia stabilized zirconia (ScSZ), gadolinium-doped ceria (GDC), samarium-doped ceria (SDC), and a mixed material of two or more of these.

The porosity of the hydrogen electrode current collecting layer 20 is not particularly limited, but may be 5% or more and 40% or less, for example.

If the hydrogen electrode current collecting layer 20 has a high porosity (for example, 25% or more), the hydrogen electrode current collecting layer 20 can be provided with a gas diffusion function. Specifically, the hydrogen electrode current collecting layer 20 diffuses the raw material gas from the hydrogen electrode-side space S1 to the hydrogen electrode active layer 12, and also diffuses the generated gas from the hydrogen electrode active layer 12 to the hydrogen electrode-side space S1. If the hydrogen electrode current collecting layer 20 has a gas diffusion function as described above, the gas permeability of the support body 11 can be improved in conjunction with the gas flow function of the through holes 50 described later.

If the hydrogen electrode current collecting layer 20 has a gas diffusion function, the Ni contained in the hydrogen electrode current collecting layer 20 also functions as a thermal catalyst that promotes the thermal reaction between H₂ generated in the hydrogen electrode active layer 12 and CO₂ contained in the raw material gas, thereby maintaining an appropriate gas composition.

If the hydrogen electrode current collecting layer 20 has a low porosity (for example, 10% or less), the rigidity of the support body 11 as a whole can be improved by increasing the strength of the hydrogen electrode current collecting layer 20.

The method for forming the hydrogen electrode current collecting layer 20 is not particularly limited, and may be tape molding, screen printing, casting, dry pressing, or the like.

### [Beam Structural Body 30]

The beam structural body 30 supports the hydrogen electrode current collecting layer 20. The beam structural body 30 functions as a support body for the electrolytic cell 10, together with the hydrogen electrode current collecting layer 20 and the frame body 40.

The beam structural body 30 is embedded in the hydrogen electrode current collecting layer 20. In the present embodiment, the beam structural body 30 being embedded in the hydrogen electrode current collecting layer 20 means that at least a portion of the beam structural body 30 is buried in the hydrogen electrode current collecting layer 20.

The beam structural body 30 has a first surface Q1 and a second surface Q2.

The first surface Q1 is the surface of the beam structural body 30 opposite to the hydrogen electrode active layer 12. Specifically, the first surface Q1 is the surface of a first beam portion 31 and a second beam portion 32, which will be described later, opposite to the hydrogen electrode active layer 12. The first surface Q1 is not covered with the hydrogen electrode current collecting layer 20. That is, the first surface Q1 is exposed from the hydrogen electrode current collecting layer 20. Therefore, in the present embodiment, the first surface Q1 forms a portion of the first main surface P1 of the support body 11.

The second surface Q2 is the surface of the beam structural body 30 facing the hydrogen electrode active layer 12. Specifically, the second surface Q2 is the surface of the first beam portion 31 and the second beam portion 32, which will be described later, facing the hydrogen electrode active layer 12. The second surface Q2 is not covered with the hydrogen electrode current collecting layer 20. That is, the second surface Q2 is exposed from the hydrogen electrode current collecting layer 20. Therefore, in the present embodiment, the second surface Q2 forms a portion of the second main surface P2 of the support body 11.

In the present embodiment, the beam structural body 30 has lattice structure in which a plurality of beam portions are arranged in a lattice pattern in the planar direction in planar view from the Z-axis direction. The lattice structure is structure in which a plurality of beam portions are periodically arranged in planar view from the Z-axis direction. Since the beam structural body 30 has lattice structure, the support body 11 as a whole can be improved in rigidity.

Although the beam structural body 30 according to the present embodiment has tetragonal lattice structure, the shape of the lattice structure is not particularly limited. The lattice structure may be vertical lattice structure, horizontal lattice structure, hexagonal lattice structure, or the like, for example.

The beam structural body 30 can be made of forsterite (Mg₂SiO₄), magnesium silicate (MgSiO₃), zirconia (ZrO₂, including partially stabilized zirconia), magnesia (MgO), spinel (MgAl₂O₄, NiAl₂O₄), yttria stabilized zirconia (YSZ), calcia stabilized zirconia (CSZ), nickel (Ni), nickel oxide (NiO), alumina (Al₂O₃), nickel oxide-magnesia solid solution (MgₓNi₍₁₋ₓ₎O [0<x<1]), and a mixed material of two or more of these.

The porosity of the beam structural body 30 may be lower than the porosity of the hydrogen electrode current collecting layer 20. The porosity of the beam structural body 30 may be 0.1% or more and 15% or less, for example. The porosity of the beam structural body 30 is preferably 5% or less. This improves the strength of the beam structural body 30, thereby improving the rigidity of the support body 11 as a whole.

The electron conductivity of the beam structural body 30 may be lower than the electron conductivity of the hydrogen electrode current collecting layer 20. The beam structural body 30 may have electron insulation. The electron conductivity of the beam structural body 30 is not particularly limited, but may be 10⁻¹ S/m or less.

As shown in FIG. 2, the beam structural body 30 is constituted by a plurality of beam portions. In the present embodiment, the beam structural body 30 is constituted by four first beam portions 31 and four second beam portions 32.

The first beam portions 31 and the second beam portions 32 are embedded in the hydrogen electrode current collecting layer 20. In the present embodiment, the first beam portions 31 being embedded in the hydrogen electrode current collecting layer 20 means that the first beam portions 31 are at least partially embedded in the hydrogen electrode current collecting layer 20. Similarly, the second beam portions 32 being embedded in the hydrogen electrode current collecting layer 20 means that the second beam portions 32 are at least partially embedded in the hydrogen electrode current collecting layer 20.

The first beam portions 31 and the second beam portions 32 are formed in a columnar shape. The first beam portions 31 and the second beam portions 32 extend along planar directions perpendicular to the Z-axis direction (stacking direction). In the present embodiment, the first beam portions 31 extend along the Y-axis direction, and the second beam portions 32 extend along the X-axis direction. Therefore, in planar view from the Z-axis direction, the angle formed by the second beam portions 32 with respect to the first beam portions 31 is 90 degrees. However, the angle formed by the second beam portions 32 with respect to the first beam portions 31 may be less than 90 degrees.

Both ends of each first beam portion 31 in the Y-axis direction are coupled to the frame body 40. The first beam portions 31 may be formed integrally with the frame body 40. Both ends of each second beam portion 32 in the X-axis direction are coupled to the frame body 40. The second beam portions 32 may be formed integrally with the frame body 40.

The beam structural body 30 according to the present embodiment has four first beam portions 31 and four second beam portions 32, but the number of first beam portions 31 and the number of second beam portions 32 are not particularly limited as long as they are one or more. The beam structural body 30 may have only either the first beam portions 31 or the second beam portions 32.

The method for forming the beam structural body 30 is not particularly limited, and may be extrusion molding, tape molding, printing lamination, casting, dry pressing, or the like.

### [Frame Body 40]

The frame body 40 is formed in a frame shape. The frame body 40 surrounds the side peripheries of the hydrogen electrode current collecting layer 20 and the beam structural body 30. The side peripheries of the hydrogen electrode current collecting layer 20 and the beam structural body 30 refer to the peripheries of the side surfaces of the hydrogen electrode current collecting layer 20 and the beam structural body 30 along the thickness direction. The frame body 40 functions as a support body for the electrolytic cell 10, together with the hydrogen electrode current collecting layer 20 and the beam structural body 30. In the present embodiment, the frame body 40 covers the entire side surfaces of the hydrogen electrode current collecting layer 20.

In the present embodiment, as shown in FIG. 2, the planar shape of the frame body 40 is rectangular. However, the planar shape of the frame body 40 may be circular, elliptical, or polygonal with three or more corners, in accordance with the planar shape of the hydrogen electrode current collecting layer 20.

The frame body 40 is coupled to the beam structural body 30. The frame body 40 may be formed integrally with the beam structural body 30.

The frame body 40 can be made of forsterite (Mg₂SiO₄), magnesium silicate (MgSiO₃), zirconia (ZrO₂, including partially stabilized zirconia), magnesia (MgO), spinel (MgAl₂O₄, NiAl₂O₄), yttria stabilized zirconia (YSZ), calcia stabilized zirconia (CSZ), nickel (Ni), nickel oxide (NiO), alumina (Al₂O₃), nickel oxide-magnesia solid solution (MgₓNi₍₁₋ₓ₎O [0<x<1]), and a mixed material of two or more of these.

The porosity of the frame body 40 may be lower than the porosity of the hydrogen electrode current collecting layer 20. The porosity of the frame body 40 can be 0.1% or more and 15% or less, for example. The porosity of the frame body 40 is preferably 5% or less. This imparts gas sealing properties to the frame body 40, so as to suppress the case where the raw material gas flowing from the hydrogen electrode-side space S1 to the hydrogen electrode active layer 12 passes through the frame body 40 and returns to the hydrogen electrode-side space S1. This improves the efficiency of gas supply from the hydrogen electrode-side space S1 to the hydrogen electrode active layer 12.

The electron conductivity of the frame body 40 may be lower than the electron conductivity of the hydrogen electrode current collecting layer 20. The frame body 40 may have electron insulation. The electron conductivity of the frame body 40 is not particularly limited, but can be 10⁻¹ S/m or less.

The method for forming the frame body 40 is not particularly limited, and may be extrusion molding, tape molding, printing lamination, casting, dry pressing, or the like.

### [Through Holes 50]

As shown in FIG. 1, the through holes 50 penetrate the support body 11 along the Z-axis direction. The through holes 50 penetrate the support body 11 from the first main surface P1 to the second main surface P2. The through holes 50 are hollow inside. The through holes 50 are open at both the first main surface P1 and the second main surface P2.

The through holes 50 provide a gas distribution function to the support body 11. Specifically, the through holes 50 can guide the raw material gas from the hydrogen electrode-side space S1 to the hydrogen electrode active layer 12, and can also guide the generated gas from the hydrogen electrode active layer 12 to the hydrogen electrode-side space S1.

The through holes 50 provide a stress relaxation function to the support body 11. Specifically, the through holes 50 deform in response to thermal stress generated inside the support body 11 along with temperature rises and falls during reduction treatment or operation, thereby suppressing warping of the support body 11. This suppresses the occurrence of warping in the electrolytic cell 10.

In the present embodiment, the through holes 50 are surrounded by the beam structural body 30 as shown in FIG. 1. Specifically, the through holes 50 are gaps between the first beam portions 31 and the second beam portions 32. The size of the through holes 50 can be adjusted according to the spacing between the first beam portions 31 and the second beam portions 32. The positions of the through holes 50 and the number thereof can be changed as appropriate.

### [Hydrogen Electrode Active Layer 12]

The hydrogen electrode active layer 12 functions as a cathode. The hydrogen electrode active layer 12 is disposed on the support body 11. The hydrogen electrode active layer 12 is covered with the electrolyte layer 13.

A raw material gas is supplied to the hydrogen electrode active layer 12 through the hydrogen electrode current collecting layer 20 and the through holes 50. In the present embodiment, the raw material gas contains at least H₂O.

If the raw material gas contains only H₂O, the hydrogen electrode active layer 12 generates H₂ from the raw material gas in accordance with the electrochemical reaction of water electrolysis shown in the following formula (1):

Hydrogen electrode active layer 12:H₂O+2e⁻→H₂+O²⁻ (1)

If the raw material gas contains CO₂ in addition to H₂O, the hydrogen electrode active layer 12 generates H₂, CO, and O²⁻ from the raw material gas in accordance with the co-electrochemical reactions shown in the following formulas (2), (3), and (4):

Hydrogen electrode active layer 12:CO₂+H₂O+4 e⁻→CO+H₂+2O²⁻ (2)

Electrochemical reaction of H₂O:H₂O+2 e⁻→H₂+O²⁻ (3)

Electrochemical reaction of CO₂:CO₂+2 e⁻→CO+O²⁻ (4)

The hydrogen electrode active layer 12 is a porous body having electron conductivity. The hydrogen electrode active layer 12 may have ion conductivity. The hydrogen electrode active layer 12 can be made of YSZ, CSZ, ScSZ, GDC, (SDC), (La, Sr) (Cr, Mn)O₃, (La, Sr)TiO₃, Sr₂ (Fe, Mo)₂O₆, (La, Sr)VO₃, (La, Sr)FeO₃, a mixed material of two or more of these, or a composite of one or more of these with NiO, for example.

The porosity of the hydrogen electrode active layer 12 is not particularly limited, but may be 20% or more and 40% or less, for example. The thickness of the hydrogen electrode active layer 12 is not particularly limited, but may be 5 μm or more and 50 μm or less, for example.

The method for forming the hydrogen electrode active layer 12 is not particularly limited, and may be tape molding, screen printing, casting, dry pressing, or the like.

### [Electrolyte Layer 13]

The electrolyte layer 13 is interposed between the hydrogen electrode active layer 12 and the oxygen electrode layer 15. In the present embodiment, the reaction prevention layer 14 is interposed between the electrolyte layer 13 and the oxygen electrode layer 15, so that the electrolyte layer 13 is interposed between the hydrogen electrode active layer 12 and the reaction prevention layer 14 and is connected to both the hydrogen electrode active layer 12 and the reaction prevention layer 14.

The electrolyte layer 13 covers the hydrogen electrode active layer 12. As shown in FIG. 1, the electrolyte layer 13 preferably covers the entire surface of the hydrogen electrode active layer 12. The outer periphery of the electrolyte layer 13 is connected to the frame body 40.

The electrolyte layer 13 has the function of transmitting O²⁻ generated in the hydrogen electrode active layer 12 to the oxygen electrode layer 15. The electrolyte layer 13 is a dense body that has ion conductivity and has no electron conductivity. The electrolyte layer 13 can be made of YSZ, GDC, ScSZ, SDC, lanthanum gallate (LSGM), or the like, for example.

The porosity of the electrolyte layer 13 is not particularly limited, but may be 0.1% or more and 7% or less, for example. The thickness of the electrolyte layer 13 is not particularly limited, but may be 1 μm or more and 100 μm or less, for example.

The method for forming the electrolyte layer 13 is not particularly limited, and may be tape molding, screen printing, casting, dry pressing, or the like.

### [Reaction Prevention Layer 14]

The reaction prevention layer 14 is interposed between the electrolyte layer 13 and the oxygen electrode layer 15. The reaction prevention layer 14 is disposed on the side opposite to the hydrogen electrode active layer 12 with respect to the electrolyte layer 13. The reaction prevention layer 14 suppresses reaction of the constituent elements of the electrolyte layer 13 with the constituent elements of the oxygen electrode layer 15 to form a layer with high electrical resistance.

The reaction prevention layer 14 is made of an ion conductive material. The reaction prevention layer 14 can be made of GDC, SDC, or the like.

The porosity of the reaction prevention layer 14 is not particularly limited, but may be 0.1% or more and 50% or less, for example. The thickness of the reaction prevention layer 14 is not particularly limited, but may be 1 μm or more and 50 μm or less, for example.

The method for forming the reaction prevention layer 14 is not particularly limited, and may be tape molding, screen printing, casting, dry pressing, or the like.

### [Oxygen Electrode Layer 15]

The oxygen electrode layer 15 functions as an anode. The oxygen electrode layer 15 is disposed on the side opposite to the hydrogen electrode active layer 12 with respect to the electrolyte layer 13. In the present embodiment, since the reaction prevention layer 14 is interposed between the electrolyte layer 13 and the oxygen electrode layer 15, the oxygen electrode layer 15 is connected to the reaction prevention layer 14. If the reaction prevention layer 14 is not interposed between the electrolyte layer 13 and the oxygen electrode layer 15, the oxygen electrode layer 15 is connected to the electrolyte layer 13.

The oxygen electrode layer 15 generates O₂ from O²⁻ transmitted from the hydrogen electrode active layer 12 through the electrolyte layer 13 according to the chemical reaction in Formula (5) below. The O₂ generated in the oxygen electrode layer 15 is released into the oxygen electrode-side space S2.

Oxygen electrode layer 15:2O²⁻→O₂+4 e⁻ (5)

The oxygen electrode layer 15 is a porous body having ion conductivity and electron conductivity. The oxygen electrode layer 15 can be made of a composite material of one or more of (La, Sr) (Co, Fe)O₃, (La, Sr)FeO₃, La(Ni, Fe)O₃, (La, Sr)CoO₃, and (Sm, Sr)CoO₃ with an ion conductive material (such as GDC).

The porosity of the oxygen electrode layer 15 is not particularly limited, but may be 20% or more and 60% or less, for example. The thickness of the oxygen electrode layer 15 is not particularly limited, but may be 1 μm or more and 100 μm or less, for example.

The method for forming the oxygen electrode layer 15 is not particularly limited, and may be tape molding, screen printing, casting, dry pressing, or the like.

### MODIFICATIONS OF EMBODIMENTS

Although embodiments of the present invention have been described above, the present invention is not limited to these, and various modifications are possible without departing from the spirit of the present invention.

### [Modification 1]

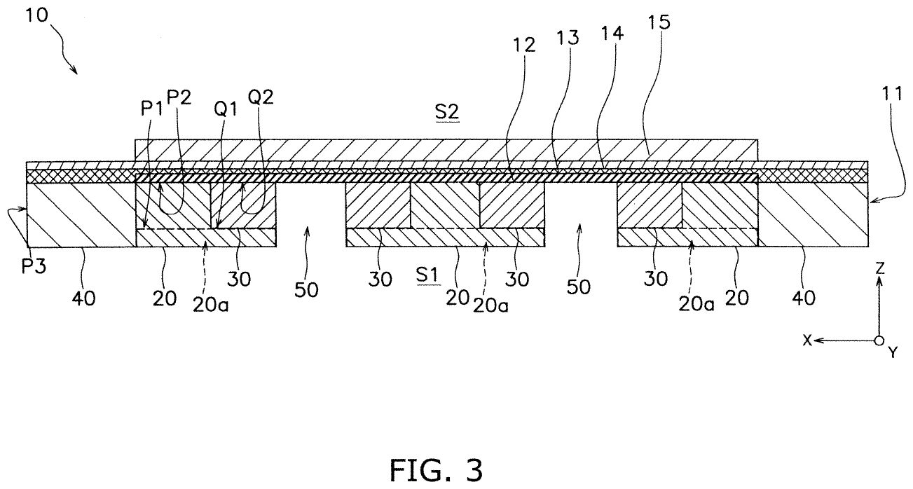

In the above-described embodiments, the first surface Q1 of the beam structural body 30 (specifically, the first and second beam portions 31 and 32) is not covered with the hydrogen electrode current collecting layer 20. However, as shown in FIG. 3, the first surface Q1 may be covered with the hydrogen electrode current collecting layer 20. Accordingly, a portion of the hydrogen electrode current collecting layer 20 is formed as an outer layer-shaped portion 20a on the side opposite to the hydrogen electrode active layer 12 with respect to the beam structural body 30. This suppresses the blocking of a flow of electrons between the hydrogen electrode current collecting layer 20 and the separator by the beam structural body 30.

### [Modification 2]

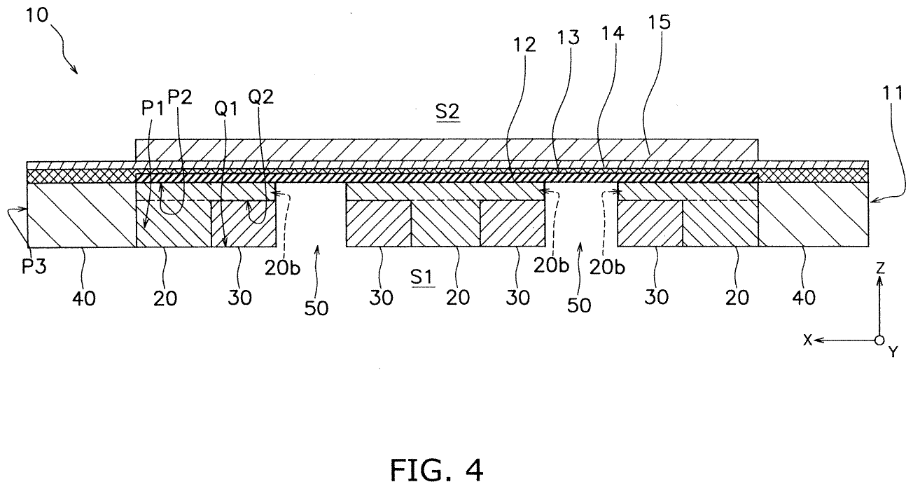

In the above-described embodiments, the second surface Q2 of the beam structural body 30 (specifically, the first and second beam portions 31 and 32) is not covered with the hydrogen electrode current collecting layer 20. However, as shown in FIG. 4, the second surface Q2 may be covered with the hydrogen electrode current collecting layer 20. Accordingly, a portion of the hydrogen electrode current collecting layer 20 is formed as an inner layer-shaped portion 20b between the beam structural body 30 and the hydrogen electrode active layer 12. This further improves the gas diffusion function of the hydrogen electrode current collecting layer 20.

### [Modification 3]

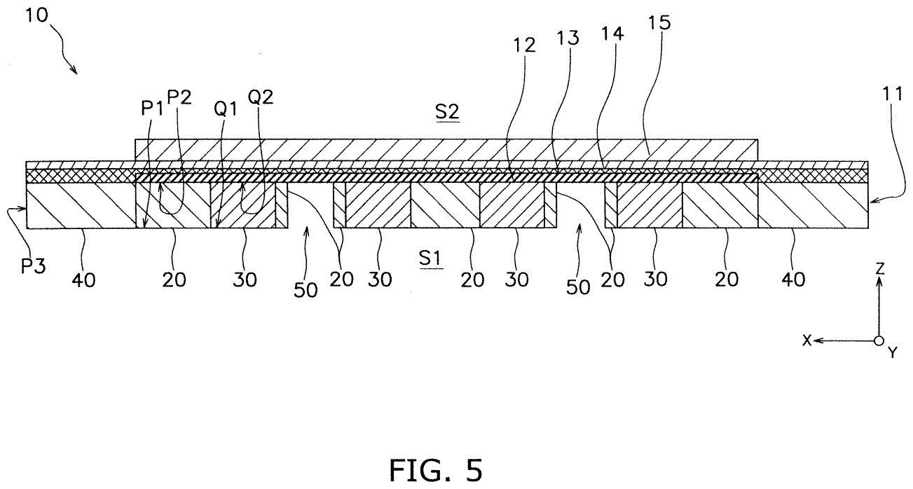

In the above-described embodiments, the through-holes 50 are surrounded by the beam structural body 30. However, as shown in FIG. 5, through-holes 50 may be surrounded by the hydrogen electrode current collecting layer 20. In this case, the through holes 50 can be formed by processing (for example, drilling) the hydrogen electrode current collecting layer 20, so that the size of the through holes 50 can be easily adjusted. In addition, the volume of the hydrogen electrode current collecting layer 20 can be increased, so that the current collecting function of the hydrogen electrode current collecting layer 20 can be further improved. Note that, although the through holes 50 are entirely surrounded by the hydrogen electrode current collecting layer 20 in FIG. 5, a portion of the beam structural body 30 may be exposed to the through holes 50.

### [Modification 4]

In the above-described embodiments, the frame body 40 surrounds the side peripheries of the hydrogen electrode current collecting layer 20 and the beam structural body 30. In addition, the frame body 40 may also surround the side periphery of the hydrogen electrode active layer 12, and may further surround the side periphery of the electrolyte layer 13.

### [Modification 5]

In the above-described embodiments, the support body 11 has the frame body 40. However, the support body 11 may not have the frame body 40. In this case, the hydrogen electrode current collecting layer 20 and the beam structural body 30 function as the support body for the electrolytic cell 10.

### [Modification 6]

In the above-described embodiments, the hydrogen electrode active layer 12 functions as the cathode, and the oxygen electrode layer 15 functions as the anode. Alternatively, the hydrogen electrode active layer 12 may function as the anode, and the oxygen electrode layer 15 may function as the cathode. In this case, the constituent materials of the hydrogen electrode active layer 12 and the oxygen electrode layer 15 are interchanged, and the raw material gas is passed over the outer surface of the hydrogen electrode active layer 12. The hydrogen electrode current collecting layer 20 functions as the oxygen electrode current collecting layer, but the configuration and function of the oxygen electrode current collecting layer are the same as those of the hydrogen electrode current collecting layer 20 in the above-described embodiments.

### [Modification 7]

In the above-described embodiments, the electrolytic cell 10 is an example of an electrochemical cell. However, the electrochemical cell is not limited to an electrolytic cell. “Electrochemical cell” is a general term for elements in which a pair of electrodes are arranged such that an electromotive force is generated from an overall oxidation-reduction reaction in order to convert electrical energy into chemical energy, and elements that convert chemical energy into electrical energy. Therefore, electrochemical cells include fuel cells that use oxide ions or protons as carriers, for example.

### REFERENCE SIGNS LIST

10 Electrolytic cell
11 Support body
12 Hydrogen electrode active layer
13 Electrolyte layer
14 Reaction prevention layer
15 Oxygen electrode layer
20 Hydrogen electrode current collecting layer
30 Beam structural body
40 Frame body
50 Through hole
P1 First main surface of support body
P2 Second main surface of support body
Q1 First surface of beam portion
Q2 Second surface of beam portion

1. An electrochemical cell comprising:
a support body;
a first electrode layer disposed on the support body;
an electrolyte layer disposed on the first electrode layer; and
a second electrode layer disposed on a side opposite to the first electrode layer with respect to the electrolyte layer, wherein
the support body has a current collecting layer, a beam portion embedded in the current collecting layer, and a through hole penetrating along a stacking direction from a first main surface on a side opposite to the first electrode layer to a second main surface facing the first electrode layer.

2. The electrochemical cell according to claim 1, wherein
a first surface of the beam portion on a side opposite to the first electrode layer is covered with the current collecting layer.

3. The electrochemical cell according to claim 1, wherein
a second surface of the beam portion facing the first electrode layer is covered with the current collecting layer.

4. The electrochemical cell according to claim 1, wherein
the support body has a frame body, the frame body surrounding a side periphery of the current collecting layer and being coupled to the beam portion.

5. The electrochemical cell according to claim 1, wherein
the support body has a beam structural body constituted by a plurality of the beam portions.

6. The electrochemical cell according to claim 5, wherein
the beam structural body has lattice structure.
